(19) United States
(12) Patent Application Publication
(10) Pub. No.: US 2023/0256769 A1
(43) Pub. Date: Aug. 17, 2023

(54) MAGNETIC WRITING BOOK

(71) Applicant: Zhuchun CHEN, Yulin (CN)

(72) Inventor: Qiang ZHANG, Yulin (CN)

(21) Appl. No.: 17/652,677

(22) Filed: Feb. 25, 2022

(30) Foreign Application Priority Data
Feb. 14, 2022 (JP) 2022-000422 U

(51) Int. Cl. B42F 11/04; H01F 7/02; B42D 3/12

(52) U.S. Cl. CPC B42F 11/04; H01F 7/02; B42D 3/12

(57) ABSTRACT

A magnetic writing book including a writing book body and a metal iron sheet with one side being provided with a backing. The writing book body includes a book back cover, a book back cover and a cylindrical permanent magnet. The backing is pasted on a wall surface or an object with non-magnetic attraction, and the magnetic writing book with adhesion on any non-metal wall surface is realized. One end of the cylindrical permanent magnet is fixedly connected with the book back cove, an other end of the cylindrical permanent magnet penetrates an upper half of each page of the writing pages.

### FIELD OF TECHNOLOGY

The present invention relates to a magnetic stationery, in particular to a magnetic writing book.

### BACKGROUND

According to the magnetic writing book disclosed by the prior art, a magnetic force component is mostly arranged outside the magnetic writing book and can only be attached to a metal surface of iron, cobalt and nickel, and a rubber magnetic sheet, is usually directly adhered to a back of the writing book, which is not only unsightly, and its application scenarios cannot be changed at will, but also easy to fall off. This type of writing book is made by gluing heads of writing pages together, and it is easy to fall off, in the prior art, the back of the writing book is generally provided with a rubber, magnetic block, so that risks of falling off and damage exist, and the magnetic force is not sufficient; for a slightly larger or heavier writing book, it will be easy to fall off since the magnetic, force of the rubber magnetic block is not sufficient; and the permanent magnetic metal iron sheet particles used in the present invention have stronger magnetic force, the number of the embedded magnet particles can be increased according to the weight requirement to meet the requirement of the magnetic force, and the magnet particle being embedded into a book is more stable, and the risk of falling off and damage is avoided.

### SUMMARY

The present invention aims at providing a magnetic writing book, which realizes the magnetic writing book of adhesive attraction on any non-metallic wall surface, and the permanent magnet is embedded in the writing book, so that a magnet is not easy to fall off.

In order to achieve the above purpose, the present invention provides the following technical solution:

a magnetic writing book including a writing book body including writing pages and a book back cover fixedly connected with a permanent magnet, wherein the magnetic writing book further includes a metal iron sheet with one side being provided with a backing, and the side being provided with the backing can be pasted on a wall surface or an object with non-magnetic attraction, and the permanent magnet is magnetically attracted and connected with the metal iron sheet.

Preferably, the permanent magnet is embedded inside the writing pages and bonded to an upper half of the book back cover.

Preferably, at least two of the permanent magnets are provided.

Preferably, each of the writing pages of the writing book body is provided with a die cutting tooth line for tearing off the writing page more neatly and quickly.

Preferably, the magnetic writing book further includes a book cover, the book cover and the book back cover are integrally arranged, and the book cover is fixedly connected with the writing pages.

According to the technical solution of the magnetic writing notebook disclosed by the present invention, the permanent magnet is wrapped on the back cover of the magnetic writing notebook, a metal iron sheet can be directly pasted on a wall body to be pasted, and then the metal iron sheet is in attraction connection with the permanent magnet, so that the operation difficulty is reduced, the replacement time and the working intensity are greatly reduced, the cost is saved, and the magnetic writing book has a wide range of application scenarios, may not easily fall off by nailing and gluing at the position where the magnet is loaded. Each page should have a die cutting tooth line, so that unwanted writing pages can be directly and neatly torn off without tearing the magnetics writing book.

### BRIEF DESCRIPTION OF THE DRAWINGS

The accompanying drawings, forming part of the present application, serve to provide a further understanding for the present invention, and the exemplary embodiments of the present invention, as well as the illustrations thereof, serve to explain the present invention and do not constitute an undue limitation of the present invention. In the drawings:

FIG. 1 is a schematic structural diagram of an embodiment of a magnetic writing book of the present invention.

FIG. 2 is a schematic diagram of a state in which a writing page of the magnetic writing book of the present invention is torn off.

Illustration of reference signs: 1-writing book body; 2-permanent magnet; 3-metal iron sheet; 4-writing page; 5-die cutting tooth line; 11-book back cover; 12-book cover.

### DETAILED DESCRIPTION OF THE EMBODIMENTS

The present invention will be described in detail below with reference to the accompanying drawings and in conjunction with embodiments. The various examples are provided by way of interpretation of the present invention and not limiting the present invention. Indeed, it will be apparent, to those skilled in the art that modifications and variations may be made in the present invention without departing from the scope or spirit of the present invention. For example, features shown or described as part of one embodiment may be used in another embodiment to produce yet another embodiment. It is therefore desirable that the present invention encompass such modifications and variations falling within the scope of the appended claims and their equivalents.

In the description of the present invention, the terms “longitudinal”, “transverse”, “up”, “down”, “front”, “back”, “left”, “right”, “vertical”, “horizontal”, “top”, “bottom” and the like denote orientation or positional relationships based on those shown in the drawings and are intended for ease of description only and not to require that the present invention must be constructed and operated in a particular orientation and therefore cannot be construed as limiting, to the present invention. The terms “joint”, “connect” and “set” used in the present invention should be understood in a broad sense, for example, may be a fixed connection or a detachable connection; it can be a direct connection or an indirect connection through intermediate components; and it may be a wired electrical connection, a radio connection, or a wireless communication signal connection, and the specific meanings of the above terms may be understood by those of ordinary skill in the art according to a specific situation.

One or more examples of the present invention are shown in the accompanying drawings. The detailed description uses numeric and alphabetic markers to refer to features in the drawings. Similar or like reference signs in the drawings and descriptions have been used to refer to similar or like parts of the present invention. As used herein, the terms “first”, “second” and “third” and the like are used interchangeably to distinguish one member from another and are not intended to denote the location or importance of individual members.

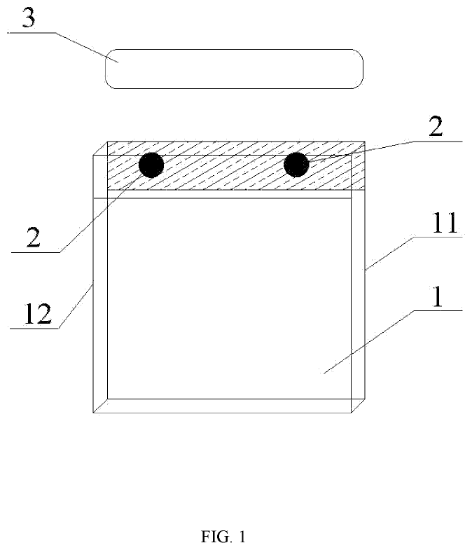

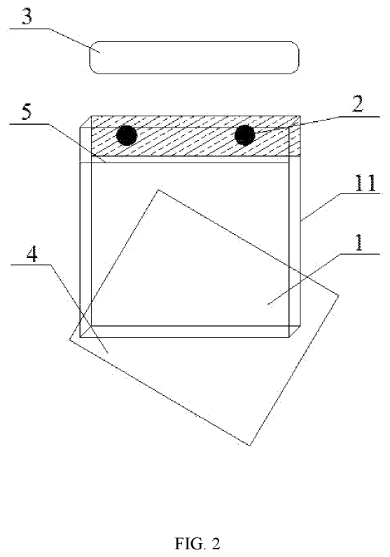

As shown in FIGS. 1 and 2, according to the embodiment of the present invention, provided is a magnetic writing book including a writing book body 1, a book back cover 11 is disposed on a wall-attached side of the writing book body 1, and a book cover 12 is disposed on a non-wall-attached side of the writing book body 1, a permanent magnet 2 is fixedly connected to an inner side surface of the book back cover 11, and the permanent magnet 2 is embedded inside the writing page 4 and bonded to an upper half of the book back cover 11.

The magnetic writing book further includes a metal iron sheet 3. The metal iron sheet 3 can be separately disposed outside the magnetic writing book, one side of the metal iron sheet 3 is provided with a backing, the side of the metal iron sheet 3 provided with the backing can be pasted on a wall surface or an object that is not magnetically attracted, and the permanent magnet 2 is magnetically connected with the metal iron sheet 3, so that the writing book body 1 is fixedly connected with the wall surface or an object to be pasted. Each of the, writing pages 4 of the writing book body 1 is provided with a die cutting tooth line 5, which is a breakpoint-type paper-to-paper connection, and is used for tearing off the writing pages 4 more neatly and quickly.

The working principle of the present invention is as follows: firstly, a side of the metal iron sheet 3 provided with a backing is pasted on a wall surface or an object to which the magnetic writing book is to be pasted, and the metal iron sheet 3 is pasted transversely. The inside of the book back cover 11 is provided with the permanent magnet 2, and the permanent magnet 2 is embedded in an upper half of the writing book body 1. Preferably, the permanent magnet 2 is embedded in the inside of the book back cover 11, and the embedded permanent magnet 2 cannot be seen from the outside, thus making, it more beautiful. After the position of the permanent magnet 2 arranged inside the book back cover 11 Corresponds to the position of the metal iron sheet 3, the permanent magnet 2 is magnetically connected to the metal iron sheet 3 with the magnetic writing book, so that the magnetic writing book is fixedly connected to the wall or the object. The structure is also suitable for magnetic calendars, magnetic wall hanging boards, and the like.

From the above description, it can be seen that the above embodiment of the present invention realizes the following technical effects:

Compared with the prior art, the magnetic writing book of the present invention has, the following technical effects:

1. The permanent magnet 2 is embedded inside the book back cover 11 of the writing book body 1, and the permanent magnet 2 is not exposed, and the external appearance of the book back cover 11 is more beautiful.

2. A metal iron sheet 3 is disposed outside the writing, book body 1, the backing of the metal iron sheet 3 can be pasted on the wall surface or object to be pasted at will, which broadens the application scene of the writing book, that is, the writing book can not only be fixedly connected to an iron surface, but also can be bonded to the surface planes of various materials can be bonded, the application scene is wider, the writing book body is suitable for various medium scenes such as glass, wood board, iron surface, wall surface or stainless steel surface.

3. The book back cover 11 at the head of the book has a short fixed position, which is also the position where the permanent magnet 2 is loaded, and is bonded together by nailing and gluing so as not to fall off easily. However, each page has a die cutting line 5, so that when the unwanted writing page is torn off, the writing page can be easily and neatly torn off.

4. The permanent magnet 2 is embedded in the writing book body 1, which has a stronger magnetic force. According to the weight requirement, the number of embedded magnet particles can be increased to meet the magnetic force requirement, and the magnet particle being embedded into a book is more stable, and the risk of falling off and damage is avoided.

The foregoing is merely a preferred embodiment of the present invention and is not intended to limit the present invention which may be subject to various modifications and variations to those skilled in the art. Any modification, equivalent replacement, improvement, etc. made within the spirit and principles of the present invention should be included in the scope of protection of the present invention.

What is claimed is:

1. A magnetic writing book comprising a writing book body and a metal iron sheet with one side being provided with a backing; wherein the writing book body comprises writing pages, a book back cover and a permanent magnet; the side being provided with the backing is pasted on a wall surface or an object with non-magnetic attraction, and the permanent magnet is magnetically attracted and connected with the metal iron sheet;
one end of the permanent magnet is fixedly connected with the book back cover, an other end of the permanent magnet is embedded in an upper half of the writing pages;
the magnetic writing book further includes a book cover, the book cover and the book back cover are integrally arranged, and the book cover is fixedly connected with the writing pages.

2. (canceled)

3. The magnetic writing book according to claim 1, wherein at least two of the permanent magnets are provided.

4. The magnetic writing book according to claim 1, wherein each of the writing pages of the writing book body is provided with a die cutting tooth line for tearing off the writing page more neatly and quickly.

5. (canceled)
